(19) United States
(12) Patent Application Publication
(10) Pub. No.: US 2017/0169505 A1
(43) Pub. Date: Jun. 15, 2017

(54) RANKING INTERFACE ELEMENTS BASED ON NESTED AUCTIONS

(71) Applicant: Hipmunk, Inc., San Francisco, CA (US)

(72) Inventors: Adam Julian Goldstein, San Francisco, CA (US); Steven Ladd Huffman, San Francisco, CA (US); Tyler Otto, San Francisco, CA (US); Steven Ji, San Francisco, CA (US)

(21) Appl. No.: 14/970,009

(22) Filed: Dec. 15, 2015

(51) Int. Cl. G06Q 30/08; G06Q 50/14; G06Q 30/06; G06Q 10/02; G06F 3/0482; G06F 3/0484

(52) U.S. Cl. CPC G06Q 30/08; G06F 3/0482; G06F 3/0484; G06Q 30/0611; G06Q 10/02; G06Q 50/14; G06Q 30/0641

(57) ABSTRACT

A nested auction machine is configured to rank and display a user interface element among a set of user interface elements based on a value received from a server of a provider. The nested auction machine may request and receive a value from a server of a provider, the value being offered for inclusion of a provider identifier within a list of identifiers. The nested auction machine may then cause display of the provider identifier at the identifier position within the list of identifiers based on the value, and concurrently rank a user interface element among a set of user interface elements based on the received value. Having ranked the user interface element based on the value, the nested auction machine may cause display of the user interface element among the set of user interface elements at a location within a graphical user interface based on the rank.

### TECHNICAL FIELD

The subject matter disclosed herein generally relates to machines configured for ranking and displaying interface elements. Specifically, the present disclosure addresses machines and methods to facilitate the presentation of interface elements at locations within a graphical user interface based on a nested auction.

### BACKGROUND

A user may operate a device to execute a search of one or more databases and obtain corresponding search results from the executed search. For example, a travel website may operate a machine that provides one or more travel search services to one or more devices belonging to one or more users. The travel website's machine may be configured (e.g., by suitable software executing on a processor of the travel search machine) to receive a search request containing search criteria, retrieve search results from a database, and cause the device of the user to display a presentation of those search results. For example, the software may be an application (e.g., a web browser operable to interact with any of various web pages).

The device of the user may additionally be configured to display the presentation of those search results within a graphical user interface (GUI). For example, a server machine of the travel website may generate a GUI, provide the generated GUI to the device of the user via one or more networks, and cause the device of the user to present (e.g., display) the GUI. One or more interactive regions (e.g., windows, buttons, images, or other selectable areas) of the GUI may be linked (e.g., hyperlinked) to information available from the server machine or available from a different server machine (e.g., a third-party server machine).

### BRIEF DESCRIPTION OF THE DRAWINGS

Some example embodiments are illustrated by way of example and not limitation in the figures of the accompanying drawings.

FIG. 1 is a network diagram illustrating a network environment suitable for displaying interface elements within a graphical user interface at locations determined based on nested auctions, according to some example embodiments.

FIG. 2 is a block diagram illustrating components of a nested auction machine suitable for displaying interface elements based on nested auctions, according to some example embodiments.

FIG. 3 is a diagram illustrating a search result presentation interface including one or more interface elements at locations determined based on a nested auction within a search result presentation interface, according to some example embodiments.

FIG. 4 is a flowchart illustrating operations of the nested auction machine in performing a method of receiving a value from a third party, and ranking a user interface element among a set of user interface elements based on the value, according to some example embodiments.

FIG. 5 is a flowchart illustrating operations of the nested auctions machine in performing a method of writing and displaying interface elements in a graphical user interface, according to some example embodiments.

FIG. 6 is a flowchart illustrating operations of the nested auctions machine in performing a method of writing and displaying interface elements in a graphical user interface, according to some example embodiments.

FIG. 7 is a flowchart illustrating operations of the nested auctions machine in performing a method of writing and displaying interface elements in a graphical user interface, according to some example embodiments.

FIG. 8 is a flowchart illustrating operations of the nested auctions machine in performing a method of writing and displaying interface elements in a graphical user interface, according to some example embodiments.

FIG. 9 is a flowchart illustrating operations of the nested auctions machine in performing a method of writing and displaying interface elements in a graphical user interface, according to some example embodiments.

FIG. 10 is a flowchart illustrating operations of the nested auctions machine in performing a method of writing and displaying interface elements in a graphical user interface, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example embodiments are described herein to disclose a nested auction machine, configured to rank and display a user interface element among a set of user interface elements based on a value received from a third party server. The term “nested auction” is used herein to describe a method of sorting a set of items, such that a ranking of a first item may be determined based upon a value, or set of values associated with the first item (e.g., in some example embodiments, values received from bidders in an auction), and the position of the first item among the set of items is based on the ranking. As used herein, a “provider” is a provider of an item or service, such as a provider of booking options for accommodations or travel arrangements. For example, the provider may operate a network based service where users may request and book services, such as a particular hotel accommodation, or travel option.

The nested auction machine may be or include a group of one or more server machines. The nested auction machine may accordingly request and receive a value from a server of a provider, the value being offered for inclusion of a provider identifier (e.g., of the provider) within a list of identifiers, the list of identifiers including one or more possible identifier positions which the provider identifier may be displayed. The nested auction machine allocates the provider identifier of the provider to an identifier position (e.g., from among the one or more possible identifier positions) within the list of identifiers based on the value, and concurrently ranks a user interface element (e.g., a window, or a view) among a set of user interface elements based on the received value. Having ranked the user interface element based on the value, the nested auction machine causes display of the user interface element among the set of user interface elements at a location within a graphical user interface based on the rank.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The nested auction machine is configured (e.g., by one or more suitable modules that include one or more processors) to receive a value from a server of a provider (e.g., a provider of a service) and display a provider identifier of the provider among a list of identifiers (e.g., of other providers), while concurrently ranking and displaying a user interface element representative of a product or service (e.g., provided by the provider) among a set of user interface elements based on the received value. The value received from the server of the provider may include, for example, a bid offered by the provider to the nested auction machine in consideration for inclusion of a provider identifier (e.g., of the provider) at an identifier position among a list of identifiers within a graphical user interface. The nested auction machine may accordingly cause display of the provider identifier among the list of identifiers based on the value received. The provider identifier may include a graphical element (e.g., an icon, or text string) indicating an identifier of the provider, wherein the provider identifier is linked (e.g., hyperlinked) to additional information available from the server of the provider.

In some example embodiments, the nested auction machine additionally receives a second value (e.g., bid) from a server of a second provider, and displays the provider identifiers of the first and second providers at locations among the list of identifiers based on a comparison of the first value and the second value. For example, the nested auction machine may allocate a most prominent location among the list of provider identifiers to the provider with the highest value. In such a case, if the first value received from the first provider is greater than the second value received from the second provider, the provider identifier of the first provider would be allocated a more prominent location among the list of identifiers than a provider identifier of the second provider. A more prominent location may, for example, be a location at the top of a list, or a location where the provider identifier may be more easily visible among the list of identifiers within the graphical user interface. The nested auction machine may then assign the first value (e.g., the greatest value) to a user interface element, in order to rank the user interface element among a set of user interface elements based on the assigned value.

In some example embodiments, the nested auction machine calculates an average value of the received values, assign the average value to the user interface element, and accordingly rank the user interface element among the set of user interface elements based on the calculated average. For example, multiple providers may submit values (e.g., bids) to be received by the nested auction machine, each of the bids offered from the providers for inclusion of an associated provider identifier (e.g., of each of the providers) at identifier positions within the list of identifiers within a user interface element associated with a particular item or service available from the providers. To rank the user interface element, the nested auction machine calculates an average of the received values, and assigns the calculated average to the user interface element. The nested auction machine may then rank the user interface element and cause display of the user interface element among the set of user interface elements based on the rank.

For purposes of illustration, consider an aisle located at the back of a supermarket, having shelf space for products, such that the shelf space may be allocated by the supermarket based on bids received from manufacturers of products. For example, an eye level shelf space may be worth more to a manufacturer of a given product than a shelf space at the top or bottom of the aisle, as the product from the manufacturer may be more easily seen by shoppers within the aisle if it is located in the eye level shelf space. The supermarket may then receive bids from manufacturers in order to then allocate shelf space based on the bids received. However, if the aisle has very little traffic (e.g., as a result of being in the back of the store, or in a generally undesirable area), the manufacturers have little incentive to bid for more desirable shelf space, since the likelihood of shoppers actually seeing their product is diminished as a result of the aisle's location. The method discussed herein provides a solution for such a scenario by “moving” the aisle itself to a higher traffic area by ranking and “displaying” the aisle, based on the bids received. Thus, the manufacturers have a greater incentive to offer bids for desirable shelf space, as the bids are concurrently applied to calculate a ranking for the aisle itself.

From a user perspective, suppose that the nested auction machine receives a bid from a provider of a service (e.g., a hotel booking service for a particular hotel). In response to receiving the value, the nested auction machine displays a provider identifier of the provider among a set of identifiers of other providers (e.g., of booking services for the particular hotel). The nested auction machine concurrently ranks and displays a user interface element associated with the particular hotel, among a set of user interface elements (e.g., of other hotels), based on the received value. When a user searches for a hotel (e.g., via a keyword search), the nested auction machine may cause display of the set of user interface elements within a graphical user interface, with the user interface element at a location based on the ranking, and concurrently cause display of the provider identifier of the provider, among the set of identifiers of providers who also offer booking options for the hotel, at a location based on the value received. In this way, the location of the user interface element associated with the particular hotel is determined based on a ranking calculated from the values received from the providers.

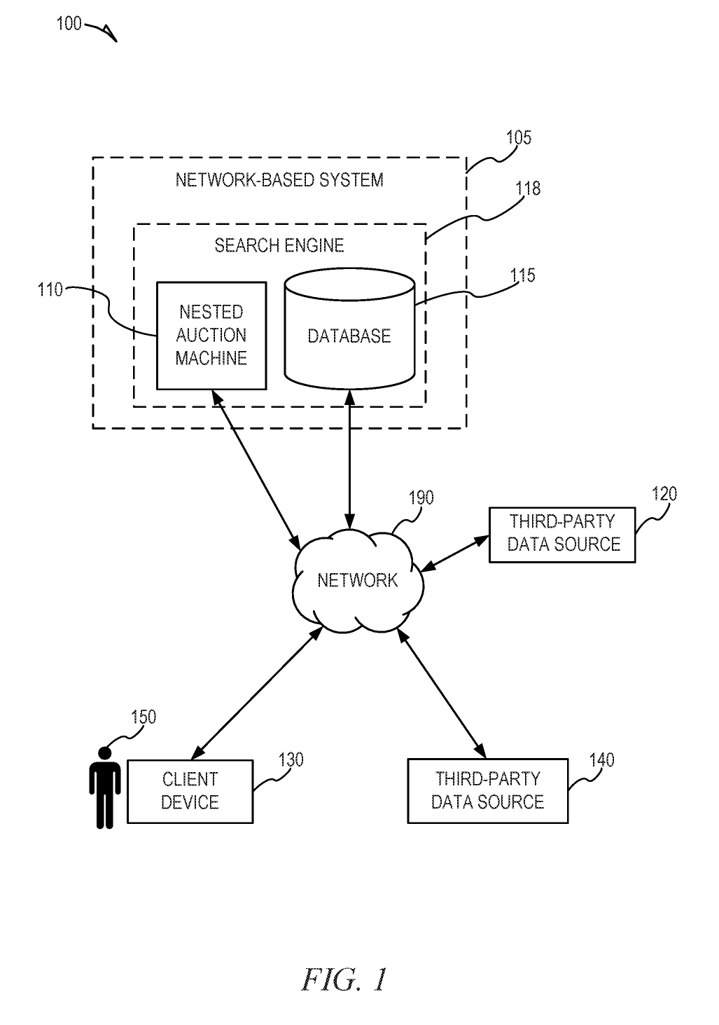

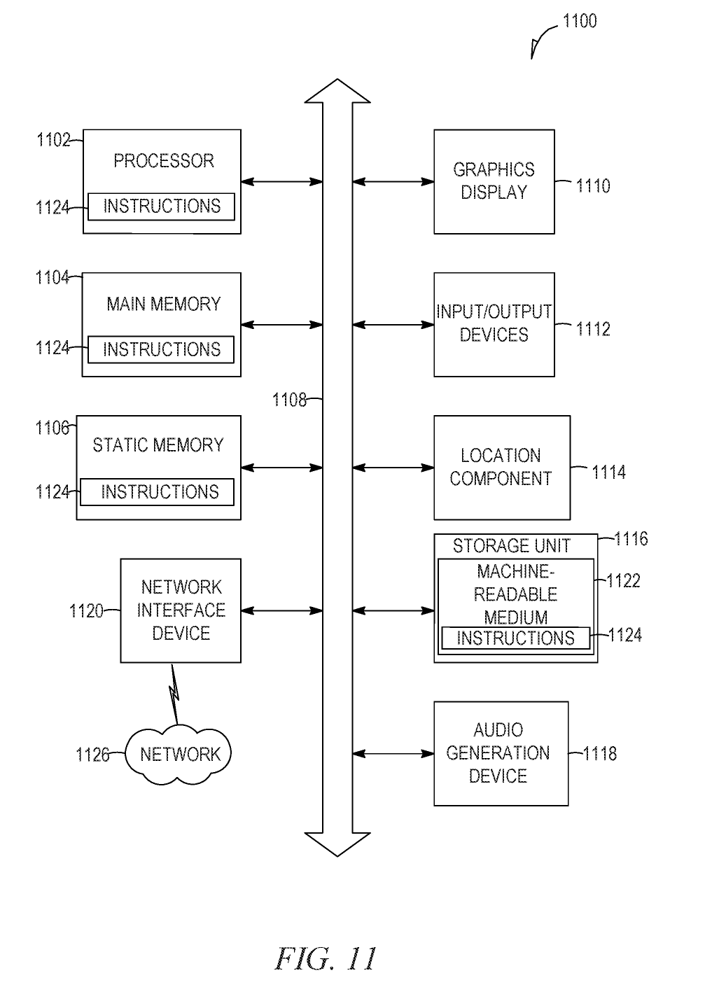

FIG. 1 is a network diagram illustrating a network environment 100 suitable for operating a nested auction machine 110, according to some example embodiments. The network environment 100 includes the nested auction machine 110, a database 115, third-party data sources 120 and 140, and a client device 130 operated by a user 150, all communicatively coupled to each other via a network 190. The nested auction machine 110, with or without the database 115, may form all or part of a search engine 118 (e.g., a travel search engine, a hotel search engine, a shopping search engine, a news search engine, or any suitable combination thereof). In addition, the search engine 118 may form all or part of a network-based system 105 (e.g., a cloud-based server system configured to provide one or more services, such as search engine services, to the client device 130). The third-party data sources 120 and 140 may be or include a database (e.g., similar to the database 115). In some example embodiments, the third-party data sources 120 and 140 are web server machines operated by third parties (e.g., a provider or business entity distinct from the business entity that operates the nested auction machine 110). The nested auction machine 110, the database 115, the third-party data sources 120 and 140, and the client device 130 may each be implemented in a computer system, in whole or in part, as described below with respect to FIG. 11.

Any of the machines, databases, or devices shown in FIG. 1 may be implemented in a special-purpose computer that has been modified (e.g., configured or programmed) by software (e.g., one or more software modules) to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The network 190 may be any network that enables communication between or among machines, databases, and devices (e.g., the nested auction machine 110 and the client device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

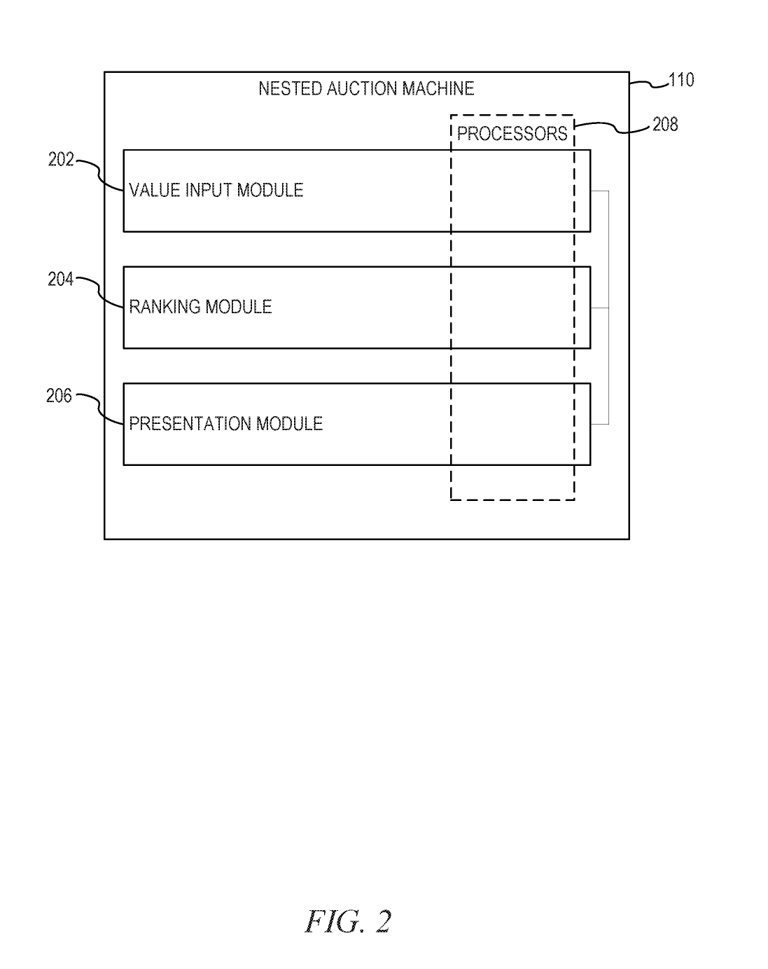

FIG. 2 is a block diagram illustrating components of the nested auction machine 110 that configure the nested auction machine 110 to receive a value from a third-party data source 120 (e.g., a provider), and rank a user interface element based on the received value, according to some example embodiments. The nested auction machine 110 is shown as including a value input module 202, a ranking module 204, and a presentation module 206, all configured to communicate with each other (e.g., via a bus, shared memory, or a switch). Any one or more of these modules may be implemented using one or more processors 208 (e.g., by configuring such one or more processors to perform functions described for that module) and hence may include one or more of the processors 208.

Any one or more of the modules described may be implemented using hardware alone (e.g., one or more of the processors 208 of a machine) or a combination of hardware and software. For example, any module described of the nested auction machine 110 may physically include an arrangement of one or more of the processors 208 (e.g., a subset of or among the one or more processors of the machine) configured to perform the operations described herein for that module. As another example, any module of the nested auction machine 110 may include software, hardware, or both, that configure an arrangement of one or more processors 208 (e.g., among the one or more processors of the machine) to perform the operations described herein for that module. Accordingly, different modules of the nested auction machine 110 may include and configure different arrangements of such processors 208 or a single arrangement of such processors 208 at different points in time. Moreover, any two or more modules of the nested auction machine 110 may be combined into a single module, and the functions described herein for a single module may be subdivided among multiple modules. Furthermore, according to various example embodiments, modules described herein as being implemented within a single machine, database, or device may be distributed across multiple machines, databases, or devices.

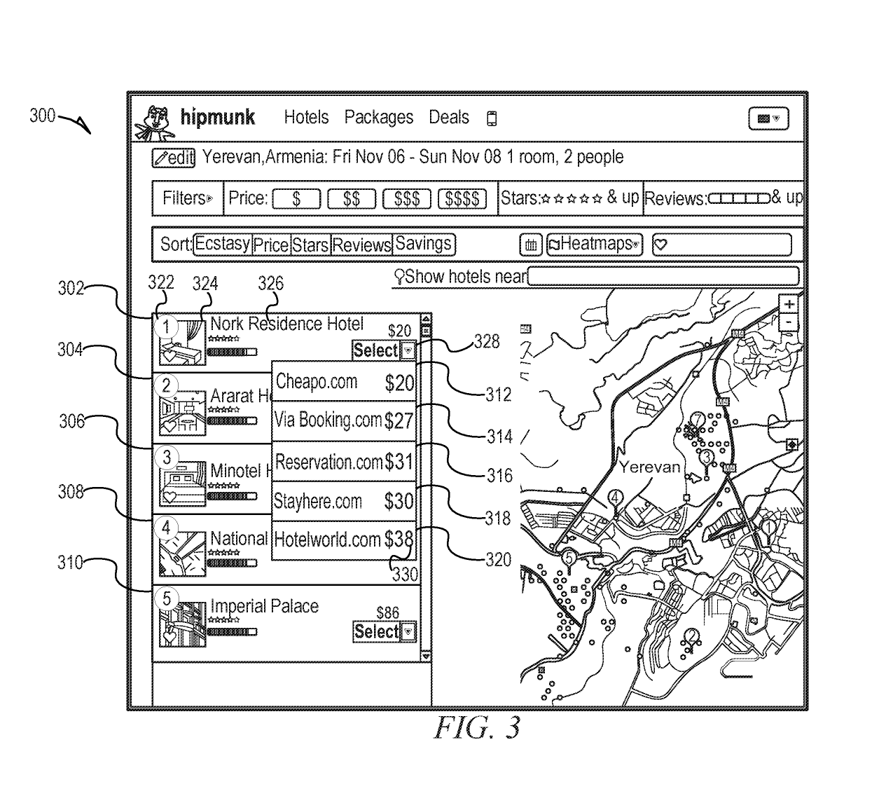

FIG. 3 is a diagram illustrating a search result presentation interface 300 generated by the presentation module 206 of the nested auction machine 110, including one or more interface elements at locations determined based on a nested auction within the search result presentation interface 300, according to some example embodiments. As shown in FIG. 3, the search result presentation interface 300 includes a list of provider identifiers (312, 314, 316, 318, and 320) at identifier locations within the search result presentation interface 300, and a set of user interface elements (302, 304, 306, 308, and 310) arranged according to a ranking determined by the various modules of the nested auction machine 110.

The set of user interface elements includes user interface elements 302, 304, 306, 308, and 310. The user interface element 302 is shown to include a rank indicator 322, a graphical representation 324, a service identifier 326, and a drop down menu 328 to access additional information about providers of the service (e.g., identified by the service identifier 326). For example, each user interface element 302, 304, 306, 308, and 310 may represent a particular item or service, and the drop down menu 328 may expand to cause display of the set of identifiers including provider identifiers 312, 314, 316, 318, and 320.

The provider identifiers 312, 314, 316, 318, and 320 are shown to include a provider identifier as a text string (e.g., cheapo.com, etc.), but could also include graphical elements as provider identifiers as well (e.g., a logo). Each provider identifier is also shown to include a price value (e.g., price value 330), displayed at a location within the provider identifier. In some example embodiments, the presentation module 206 of the nested auction machine 110 may cause display of a price value (e.g., price value 330) corresponding to a provider identifier from among the set of identifiers at a location within a user interface element (e.g., user interface element 302). For example, the nested auction machine 110 may be configured to cause display of a lowest price value among the price values associated with the provider identifiers within the associated user interface element, or in some example embodiments, the price value corresponding to the top provider identifier among the set of provider identifiers.

The rank of the user interface element 302 may be determined by the ranking module 204. For example, the ranking module 204 may receive values from one or more providers (e.g., the providers associated with the provider identifiers 312, 314, 316, 318, and 320), and calculate a ranking score for the user interface element 302 based on the received values. In some example embodiments, the ranking module 204 may compare the received values to identify the highest value, and may assign the highest received value to the user interface element 302, wherein the value may then be used to rank the user interface element 302 against the set of other user interface elements (e.g., user interface elements 304, 306, 308, and 310). In further example embodiments, the ranking module 204 may calculate an average of the received values, and assign the average to the user interface element. The calculated average may then be used to rank the user interface element (e.g., user interface element 302) against the set of other user interface elements.

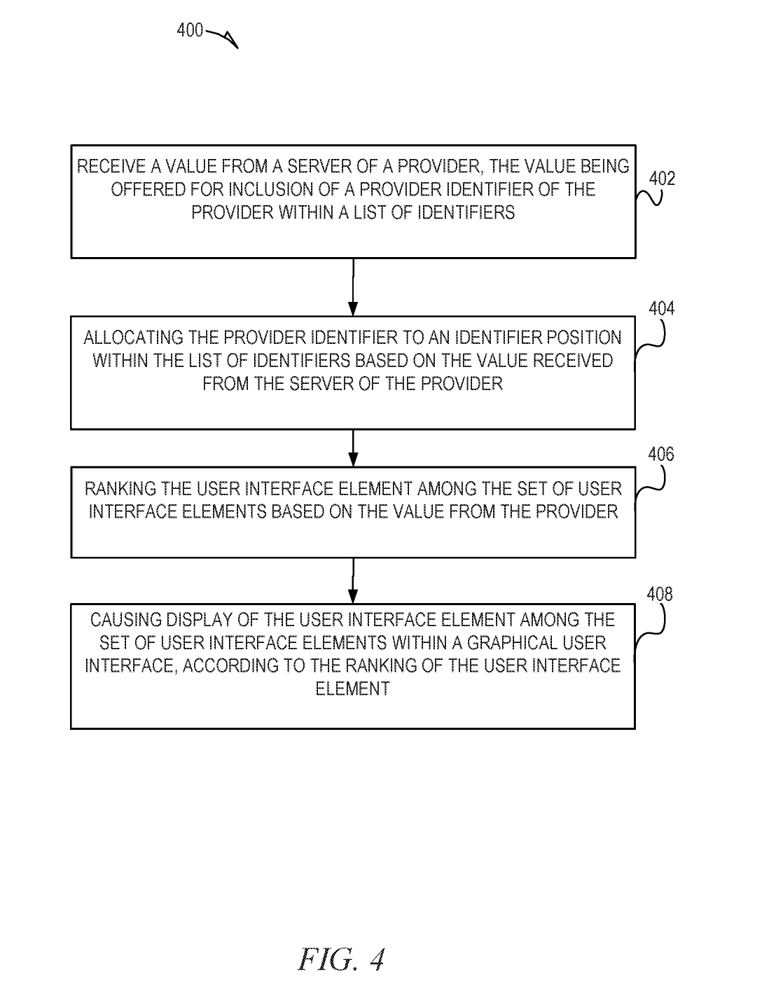

FIG. 4 is a flowchart illustrating operations of the nested auction machine 110 in performing a method 400 of receiving a value from a server of a provider (e.g., third-party data source 120) and ranking a user interface element (e.g., user interface element 302 of FIG. 3) among a set of user interface elements based on the value, according to some example embodiments. As shown in FIG. 4, one or more operations 402, 404, 406, and 408 may be performed as part (e.g., a precursor task, a subroutine, or a portion) of the method 400, according to some example embodiments.

In operation 402, the value input module 202 of the nested auction machine 110 receives a value from a server of a provider (e.g., third-party data source 120), the value being offered by the provider for inclusion of a provider identifier of the provider within a list of identifiers. The value may include, for example, a bid. The list of identifiers may include one or more identifier positions.

In some example embodiments, the provider may include a provider of a particular service, such as a travel or accommodations booking provider, and the list of identifiers may include identifiers of one or more distinct providers which offer the same service as, or a substantially similar service to, the provider (e.g., a room rate for a one night stay in a specific hotel in San Jose, Calif.).

In operation 404, the presentation module 206 allocates the provider identifier of the provider to an identifier positon (e.g., from among the one or more identifier positions) within the list of identifiers. In some example embodiments, the list of identifiers may be located within a user interface element among a set of user interface elements, as depicted in FIG. 3. For example, the list of identifiers may include the list of provider identifiers 312, 314, 316, 318, and 320, and may be accessible through a drop down menu (e.g., drop down menu 328) located at a position within a user interface element (e.g., user interface element 302).

In operation 406, the ranking module 204 ranks the user interface element among the set of user interface elements based on the value from the server of the provider. In some example embodiments, the rank may simply be based on the value received from the server of the provider. For example, the ranking module 204 may compare the value from the server of the provider to values associated with each user interface element among the set of user interface elements to determine a rank.

In operation 408, the presentation module 206 causes display of the user interface element among the set of user interface elements within a graphical user interface, according to the rank calculated by the ranking module 204. The user interface element includes the list of identifiers, with the provider identifier at the allocated identifier position, based on the value received from the server of the provider

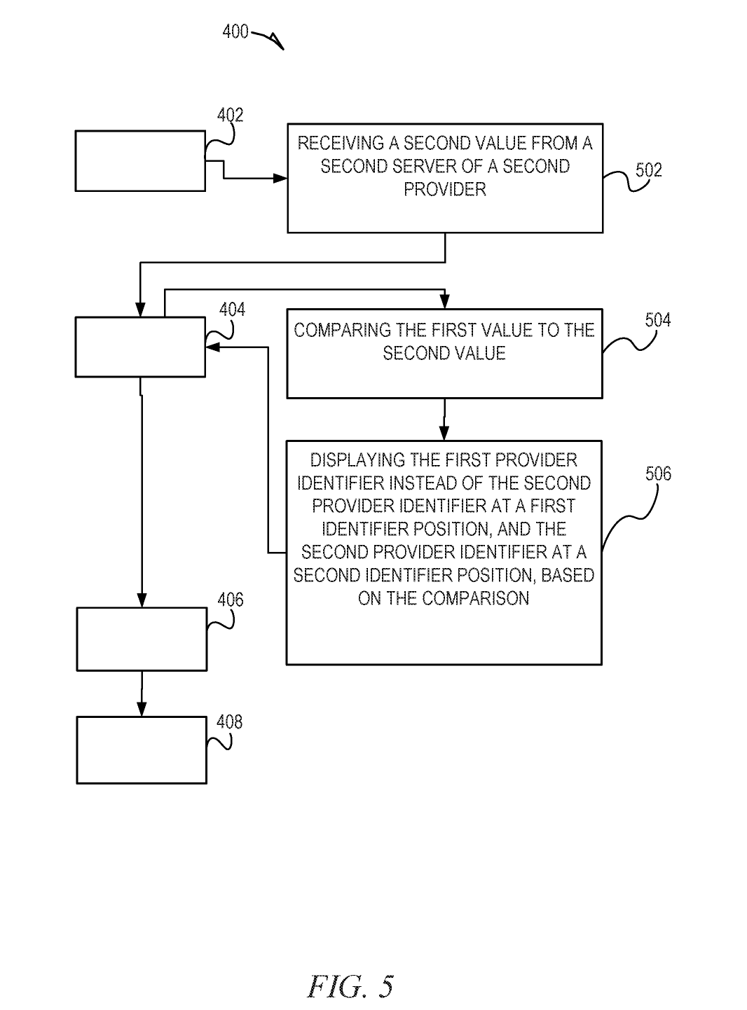

As shown in FIG. 5, one or more operations 502, 504, and 506 may be performed as part (e.g., a precursor task, a subroutine, or a portion) of operations 402 and 404 of the method 400, in which the nested auction machine 110 receives a value and ranks a user interface element based on the received value, according to some example embodiments.

Operation 502 may be performed by the value input module 202 between operations 402 and 404 of FIG. 4. The value input module 202 receives a second value from a server of a second provider (e.g., third-party data source 140), as well as the first value from the server of the first provider (e.g., third-party data source 120). The first provider and second provider may provide booking options for hotel accommodations, and the values may be provided for inclusion of a provider identifier of the providers among a list of identifiers within a user interface element associated with a particular booking option for a hotel. For example, both the first provider and the second provider may offer a booking option for a night stay in the same hotel in San Jose, Calif.

Operation 504 may be performed by the ranking module 204 as a part of operation 404. The ranking module 204 retrieves the first value and the second value from the value input module 202, and compares the first value to the second value. In some example embodiments, the comparison includes simply comparing the first value and the second value to determine the greater value between the first value and the second value. For example, in an instance where the first value is greater than the second value, the ranking module 204 would assign a higher rank to the first provider identifier.

Operation 506 may be performed by the presentation module 206 as a part of operation 404. Having ranked the provider identifiers based on the values received, the ranking module 204 transmits the ranking scores of the provider identifiers to the presentation module 206. The presentation module 206 may then display the first provider identifier at a more prominent location than the second provider identifier. For example, the first provider identifier may be located at a first position in a list of provider identifiers, with the second provider identifier at a location below the first provider identifier within the list. In some example embodiments, the first provider identifier may be visibly displayed within a user interface element, while the second provider identifier is only visible responsible to expanding a drop down menu, such as drop down menu 328 depicted in FIG. 3.

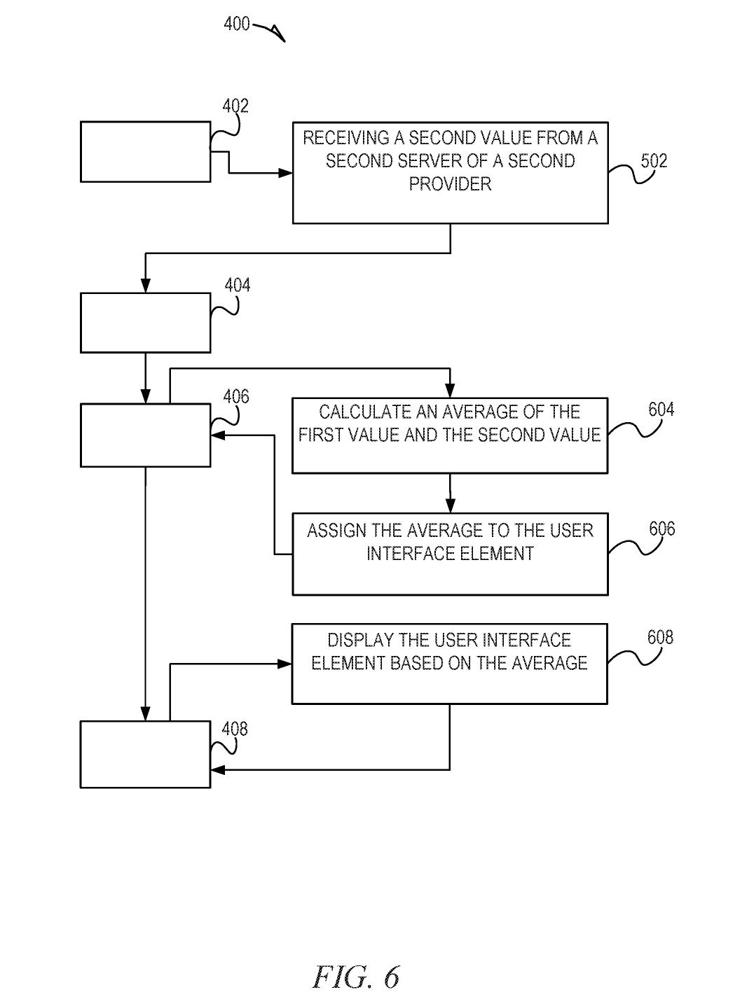

FIG. 6 is a flowchart illustrating operations of the nested auction machine 110 in performing the method 400, further including operations for receiving a second value from a second provider, calculating an average of the first value and the second value, assigning the average to a user interface element, and displaying the user interface element among a set of user interface elements based on the calculated average, according to some example embodiments.

As shown in FIG. 6, one or more operations 502, 604, 606, and 608 may be performed as part (e.g., a precursor task, a subroutine, or a portion) of operations 402, 406, and 408 of method 400, in which the ranking module 204 receives a value and ranks a user interface element based on the received value, according to some example embodiments.

As discussed with respect to FIG. 5, operation 502 may be performed by the value input module 202 as a part of operation 402, before operation 404. The value input module 202 receives a second value from a server of a second provider (e.g., third-party data source 140), as well as the first value from the server of the first provider (e.g., third-party data source 120). The first provider and second provider may provide booking options for hotel accommodations, and the values may be provided for inclusion of a provider identifier (e.g., of the providers) at identifier positions among a list of identifiers within a user interface element referencing a particular booking option for a hotel.

Operations 604 and 606 may be performed by the ranking module 204 as a part of operation 406. At operation 604, the ranking module 204 receives the first value and the second value from the value input module 202, and calculates an average of the first value and the second value. For example, calculating the average may simply include determining an arithmetic mean of the values. At operation 606, the ranking module 204 assigns the calculated average to the user interface element referencing the particular booking option. The ranking module 204 may then determine a ranking of the user interface element among a set of user interface elements based on the calculated average. For example, consider the user interface elements 302, 304, 306, 308, and 310 of FIG. 3. Each user interface element depicted therein may include a ranking score determined based on an average value calculated from values received from each provider wishing to have their associated provider identifiers (e.g., 312, 314, 316, 318, 320) displayed within the user interface element.

Consider the user interface element 302, and the list of provider identifiers 312, 314, 316, 318, and 320. Each provider identifier within the list is associated with a distinct provider, each of which submitted a value for inclusion of their associated provider identifier at an identifier position among the list of identifiers within the user interface element 302. The provider identifiers are compared by the ranking module 204, and then displayed based on the comparison, as discussed above, with respect to operations 504 and 506 of FIG. 5. The ranking module 204 may then determine a ranking score for the user interface element 302, by calculating an average value of the values received from providers represented by the provider identifiers displayed within the user interface element 302 (e.g., provider identifiers 312, 314, 316, 318, and 320).

Operation 608 may be performed by the presentation module 206 as a part of operation 408. The presentation module 206 displays the user interface element ranked by the ranking module 204 at a location among the set of user interface elements, based on the rank assigned by the ranking module 204. For example, the user interface element 302 of FIG. 3 is displayed at a position among the set of user interface elements (e.g., 302, 304, 306, 308, and 310) based on the rank determined based on the calculated average.

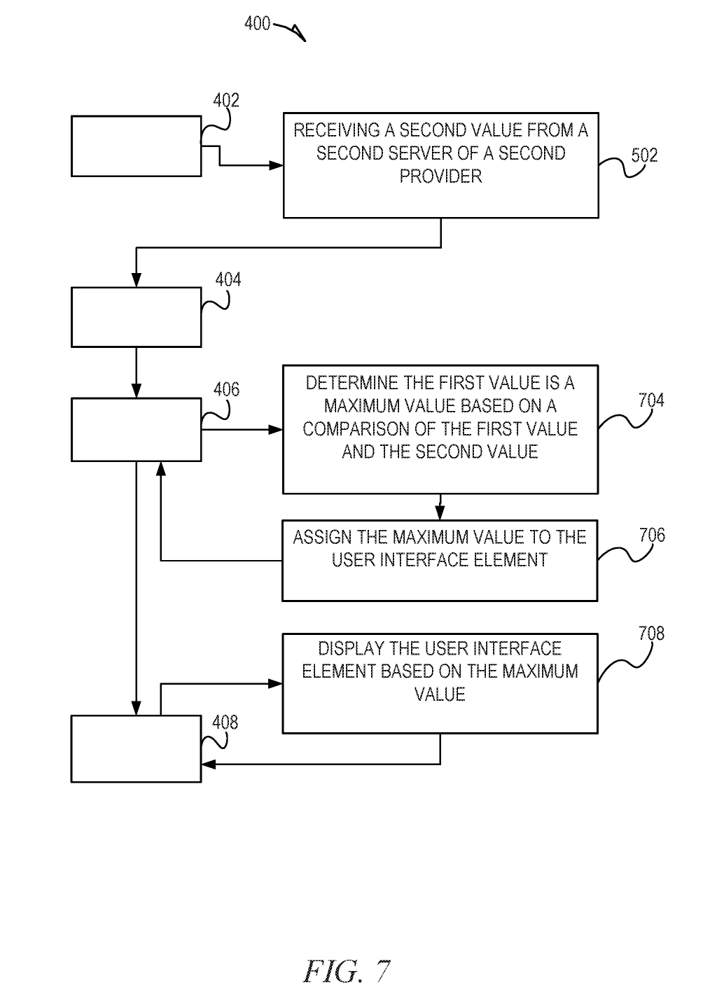

FIG. 7 is a flowchart illustrating operations of the nested auction machine 110 in performing the method 400, further including operations for receiving a second value from a second provider, determining that the first value is a maximum value based on a comparison of the first value and the second value, assigning the maximum value to the user interface element, and displaying the user interface element among the set of user interface elements based on the maximum value, according to some example embodiments.

As shown in FIG. 7, one or more operations 502, 704, 706, and 708 may be performed as part (e.g., a precursor task, a subroutine, or a portion) of operations 402, 406, and 408 of the method 400, in which the ranking module 204 receives a value and ranks a user interface element based on the received value, according to some example embodiments.

As discussed with respect to FIG. 5, operation 502 may be performed by the value input module 202 as a part of operation 402, before operation 404. The value input module 202 receives a second value from a server of a second provider (e.g., third-party data source 140), as well as the first value from the server of the first provider (e.g., third-party data source 120). The first provider and second provider may provide booking options for hotel accommodations, and the values may be provided for inclusion of a provider identifier (e.g., of the providers) at identifier positions among a list of identifiers within a user interface element referencing a particular booking option for a hotel. For example, both the first provider and the second provider may offer a booking option for a night stay in the same hotel in San Jose, Calif.

Operations 704 and 706 may be performed by the ranking module 204 as part of operation 406, where the ranking module 204 ranks the user interface element among the set of user interface elements based on the value from the provider. The ranking module 204 retrieves the first value and the second value from the value input module 202. The ranking module 204 performs a comparison of the values in order to determine a maximum value between the two. At operation 704, the ranking module determines that the first value is a maximum value based on the comparison of the first value and the second value. In response to determining that the first value is the maximum value, at operation 706 the ranking module 204 assigns the maximum value (e.g., the first value) to the user interface element, to ultimately rank the user interface element against the set of user interface elements, based on the maximum value.

Operation 708 may be performed by the presentation module 206 as a part of operation 408, where the presentation module 206 causes display of the user interface element among the set of user interface elements according to the rank. At operation 708, the user interface element is displayed among the set of user interface elements based on the rank—which in this case is based upon the maximum value assigned to the user interface element.

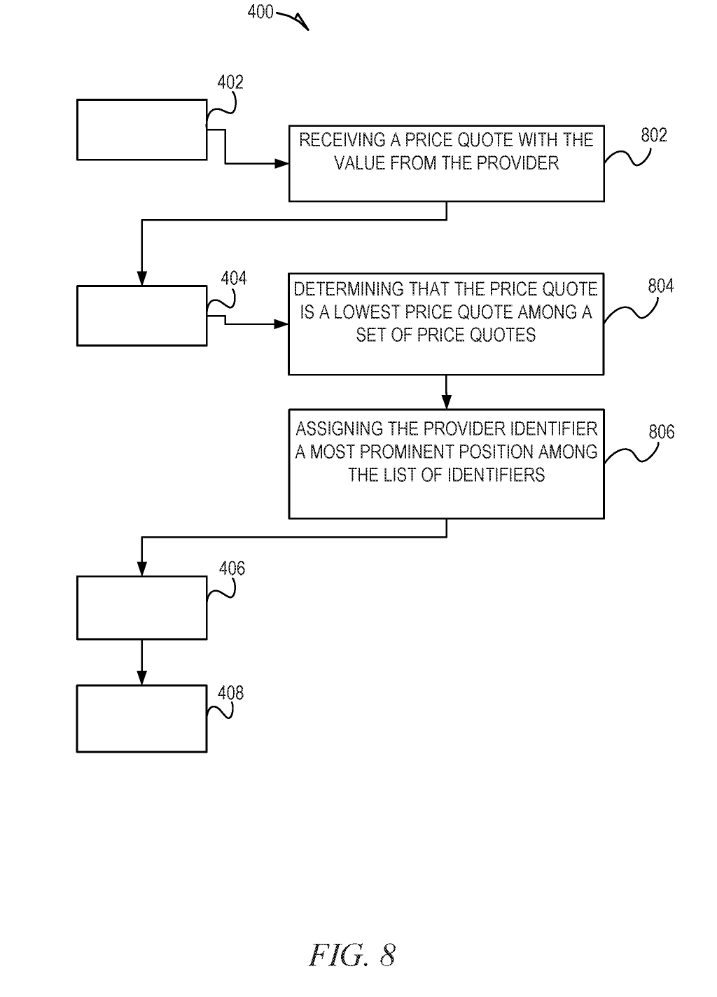

FIG. 8 is a flowchart illustrating operations of the nested auction machine 110 in performing the method 400, further including operations for receiving a price quote along with the value from the provider, determining that the price quote is a lowest price quote, and assigning the provider identifier a most prominent position, according to some example embodiments.

As shown in FIG. 8, one or more operations 802, 804, and 806 may be performed as part (e.g., a precursor task, a subroutine, or a portion) of operations 402 and 404 of the method 400, in which the ranking module 204 receives a value and ranks a user interface element based on the received value, according to some example embodiments.

Operation 802 may be performed by the value input module 202 as a part of operation 402, where the value input module 202 receives a value from a server of a provider for inclusion of a provider identifier of the provider at an identifier position within a list of identifiers. At operation 802, the value input module 202 receives a price quote from the server of the provider to be included alongside the provider identifier of the provider, as can be seen in the provider identifier 312 of FIG. 3. The price quote may, for example, indicate a price of the service (e.g., the service indicated within the user interface element 302) offered by the provider.

Operations 804 and 806 may be performed by the ranking module 204 and the presentation module 206, between operations 404 and 406. The ranking module 204 may compare the price quote received from the server of the provider against a set of price quotes associated with provider identifiers within the set of provider identifiers. At operation 804, the ranking module 204 determines that the price quote is a lowest price quote among the set of price quotes.

At operation 806, the presentation module 206 assigns the provider identifier associated with the lowest price quote to a most prominent position among the list of identifiers. In some example embodiments, the ranking module 204 may perform an additional comparison to determine if the lowest price quote is a predefined value less than the other price quotes among the set of price quotes (e.g., a delta value) before assigning the associated provider identifier the most prominent position among the list of identifiers.

Consider the set of provider identifiers 312, 314, 316, 318, and 320 depicted in FIG. 3. Each provider identifier shown includes a price quote (e.g., $20, $27, $31, $30, $38), with the provider identifier 312 located at the most prominent position among the set of provider identifiers. As discussed above with respect to operations 804 and 806, the ranking module 204 may determine that the price quote associated with the provider identifier 312 is the lowest price quote among the set of price quotes. In addition, the ranking module 204 may also perform a comparison to determine if the price quote is a predefined value less than the other price quotes among the set of price quotes before assigning the associated provider identifier (e.g., provider identifier 312) to the most prominent position. For example, the ranking module 204 may determine if the price quote is at least a predefined delta value (for example, $5) less than the next lowest price quote (e.g., $27). In other example embodiments, the delta value may be based on a percentage (e.g., lowest price quote must be at least 10% less than the next lowest to receive the most prominent location).

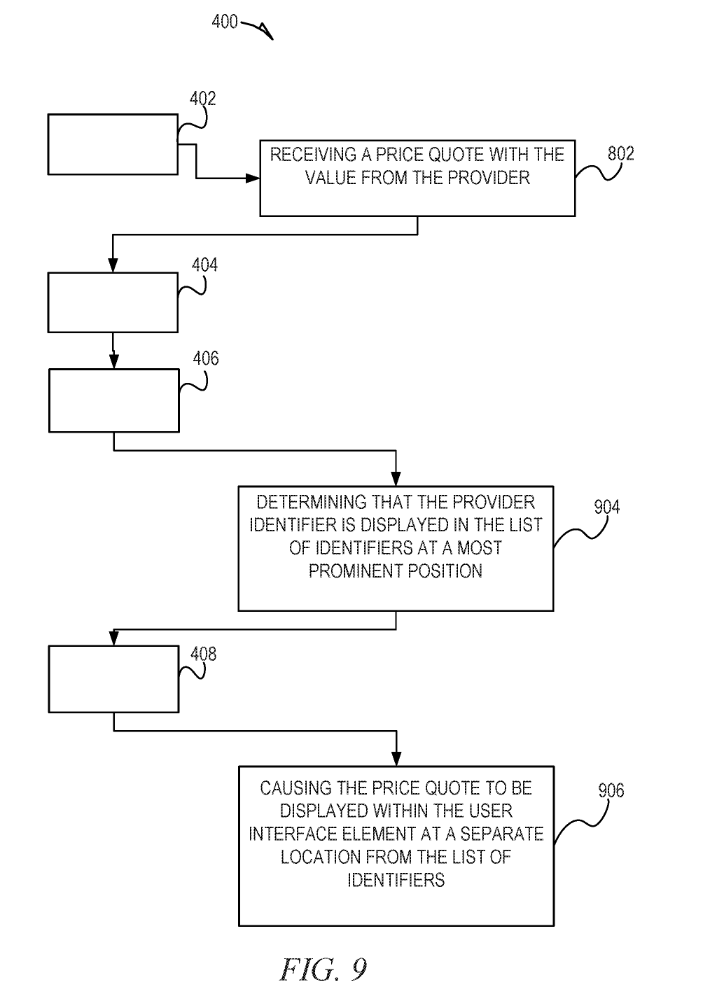

FIG. 9 is a flowchart illustrating operations of the nested auction machine 110 in performing the method 400, further including operations for receiving a price quote along with the value from the provider, determining that a provider identifier is at a most prominent position among the list of identifiers, and causing display of the price quote at a separate location within a user interface element, according to some example embodiments.

As shown in FIG. 9, one or more operations 802, 904, and 906 may be performed as part (e.g., a precursor task, a subroutine, or a portion) of operations 402, 406, and 408 of the method 400.

As discussed with reference to FIG. 8, at operation 802, the value input module 202 receives a price quote from the server of the provider to be included alongside the provider identifier of the provider, as can be seen in the provider identifier 312 of FIG. 3.

Operation 904 may be performed by the ranking module 204, between operations 406 and 408. At operation 904, the ranking module 204 identifies the provider identifier at the most prominent position among the list of identifiers. In some example embodiments, the identification may be based on a ranking score of the provider identifier, or on the provider identifier having a lowest price quote, as discussed with respect to operation 804 of FIG. 8.

Operation 906 may be performed by the presentation module 206, as a part of operation 408. At operation 906, the presentation module 206 retrieves the price quote associated with the provider identifier at the most prominent position among the list of identifiers, and causes display of the price quote within the user interface element at a separate location from the list of identifiers.

For example, consider the user interface element 302, and the provider identifier 312 of FIG. 3. As discussed above with respect to operations 904 and 906, the ranking module 204 may identify the provider identifier (e.g., provider identifier 312) at the most prominent location among the set of provider identifiers. Having identified the provider identifier 312 as the provider identifier at the most prominent location, the presentation module 206 retrieves the price quote associated with the provider identifier 312 ($20), and causes display of the price quote at a location within the user interface element 302 (e.g., the price quote displayed above the drop down menu 328).

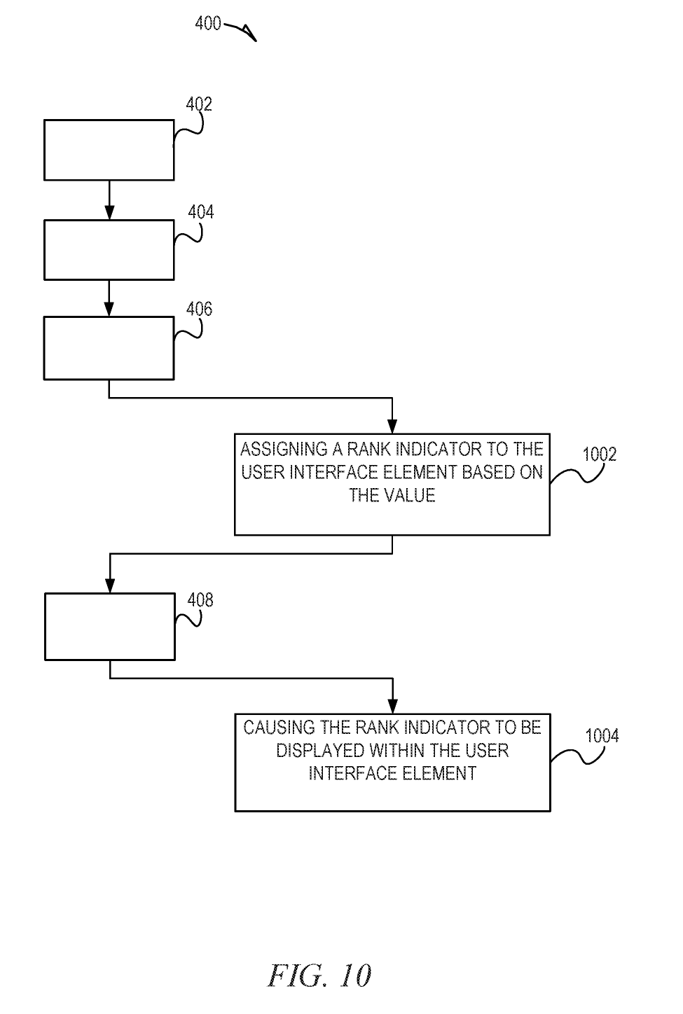

FIG. 10 is a flowchart illustrating operations of the nested auction machine 110 in performing the method 400, further including operations for assigning a rank indicator to the user interface element, and causing the rank indicator to be displayed within the user interface element, according to some example embodiments.

As shown in FIG. 10, one or more operations 1002 and 1004 may be performed as part (e.g., a precursor task, a subroutine, or a portion) of operations 406 and 408 of the method 400.

Operation 1002 may be performed by the ranking module 204, between operations 406 and 408. As in operation 406, the ranking module 204 ranks the user interface element among the set of user interface elements based on the value from the provider. In some example embodiments, the rank may simply be based on the value received from the server of the provider, or in other example embodiments discussed above, the rank may be based on other factors, such as a lowest price quote associated with a provider identifier among the set of provider identifiers. At operation 1002, having ranked the user interface element, the ranking module 204 assigns a rank indicator to the user interface element. The rank indicator may, for example, be a numerical value.

Operation 1004 may be performed by the presentation module 206, as a part of operation 408. In response to the ranking module 204 assigning the rank indicator to the user interface element, the presentation module 206 retrieves the rank indicator, and causes the rank indicator to be displayed within the user interface element. For example, consider the user interface element 302 of FIG. 3. As discussed above with respect to operation 1002, the ranking module 204 ranks the user interface element 302 based on the one or more values received from providers, and assigns a rank indicator 322 to the user interface element 302. The presentation module 206 may then cause display of the rank indicator 322 at a location within the user interface element 302.

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative example embodiments, the machine 1100 operates as a standalone device or may be communicatively coupled (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain solid-state digital microcircuits (e.g., electronic, optical, or both) that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein. In some example embodiments, the processor 1102 is a multicore CPU (e.g., a dual-core CPU, a quad-core CPU, or a 128-core CPU) within which each of multiple cores is a separate processor that is able to perform any one or more of the methodologies discussed herein, in whole or in part. Although the beneficial effects described herein may be provided by the machine 1100 with at least the processor 1102, these same effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an input/output device 1112 (e.g., a keyboard or keypad, a mouse, a trackpad), a location component 1114 (e.g., a global positioning system (GPS) receiver), a storage unit 1116, an audio generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., hypertext transfer protocol (HTTP)).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 1124 for execution by the machine 1100 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1124).

Certain example embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a CPU or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a CPU configured by software to become a special-purpose processor, the CPU may be configured as respectively different special-purpose processors (e.g., each included in a different hardware module) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. Accordingly, the operations described herein may be at least partially processor-implemented, since a processor is an example of hardware. For example, at least some operations of any method may be performed by one or more processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, by one or more processors of a machine, a value from a server of a provider, the value being offered for inclusion of a provider identifier within a list of identifiers, the provider identifier identifying the provider;
allocating the provider identifier to an identifier position within the list of identifiers based on the value from the server of the provider, the identifier position being within a user interface element among a set of user interface elements;
ranking, by one or more processors of the machine, the user interface element among the set of user interface elements based on the value from the provider; and
causing, by one or more processors of the machine, display of the user interface element among the set of user interface elements within a graphical user interface, according to the ranking of the user interface element, the displayed user interface element displaying the provider identifier within the list of identifiers and at the identifier position allocated based on the value received from the server of the provider.

2. The method of claim 1, wherein the value is a first value, the provider is a first provider, the provider identifier is a first provider identifier, the identifier position is a first identifier position, and the method further comprises:
receiving a second value from a second server of a second provider, the second value being offered for inclusion of a second provider identifier within the list of identifiers, the second provider identifier identifying the second provider;
comparing the first value to the second value; and
the display of the first provider identifier includes:
displaying the first provider identifier instead of the second provider identifier at the first identifier position, and the second provider identifier at a second identifier position within the list of identifiers based on the comparison.

3. The method of claim 1, wherein the value is a first value, the provider is a first provider, and the method further comprises:
receiving a second value from a second server of a second provider, the second value being offered for inclusion of a second provider identifier within the list of identifiers, the second provider identifier identifying the second provider; and wherein
the ranking of the user interface element includes:
calculating an average of the first value and the second value; and
assigning the average to the user interface element; and
the display of the user interface element among the set of user interface elements within the graphical user interface is based on the average.

4. The method of claim 1, wherein the value is a first value, the provider is a first provider, and the method further comprises:
receiving a second value from a second server of a second provider, the second value being offered for inclusion of a second provider identifier within the list of identifiers, the second provider identifier identifying the second provider; and wherein
the ranking of the user interface element includes:
determining that the first value is a maximum value based on a comparison of the first value to the second value; and
assigning the maximum value to the user interface element; and
the display of the user interface element among the set of user interface elements is based on the maximum value.

5. The method of claim 1, wherein the receiving of the value further comprises:
receiving a price quote with the value from the server of the provider; and
the method further comprises:
determining that the price quote is a lowest price quote among a set of price quotes by a threshold margin; and
assigning the provider identifier a most prominent position among the list of identifiers in response to determining that the price quote is the lowest price quote by the threshold margin.

6. The method of claim 1, wherein the receiving of the value further comprises:
receiving a price quote with the value from the server of the provider; and
the method further comprises:
determining that the provider identifier is displayed in the list of identifiers at a most prominent position; and
causing the price quote to be displayed within the user interface element at a separate location from the list of identifiers.

7. The method of claim 1, wherein the value is a bid for the identifier position at which the provider identifier that identifies the provider is displayable among the list of identifiers.

8. The method of claim 1, wherein the ranking of the user interface element among the set of user interface elements based on the value from the provider includes:
assigning a rank indicator to the user interface element based on the value from the provider; and wherein
the causing of the display of the user interface element among the set of user interface elements includes:
causing the rank indicator to be displayed within the user interface element.

9. The method of claim 1, wherein the user interface element includes a service identifier indicating a service offered by the provider.

10. A non-transitory machine-readable storage medium comprising instructions that, when executed by one or more processors of a machine, cause the machine to perform operations comprising:
receiving, by one or more processors of a machine, a value from a server of a provider, the value being offered for inclusion of a provider identifier within a list of identifiers, the provider identifier identifying the provider;
allocating the provider identifier to an identifier position within the list of identifiers based on the value from the server of the provider, the identifier position being within a user interface element among a set of user interface elements;
ranking, by one or more processors of the machine, the user interface element among the set of user interface elements based on the value from the provider; and
causing, by one or more processors of the machine, display of the user interface element among the set of user interface elements according to the ranking of the user interface element, within a graphical user interface, the displayed user interface element displaying the provider identifier within the list of identifiers and at the identifier position allocated based on the value received from the server of the provider.

11. The non-transitory machine-readable storage medium of claim 10, wherein the value is a first value, the provider is a first provider, the provider identifier is a first provider identifier, the identifier position is a first identifier position, and the operations further comprise:
receiving a second value from a second server of a second provider, the second value being offered for inclusion of a second provider identifier within the list of identifiers, the second provider identifier identifying the second provider;
comparing the first value to the second value; and wherein
the display of the first provider identifier includes:
displaying the first provider identifier instead of the second provider identifier at the first identifier position, and the second provider identifier at a second identifier position within the list of identifiers based on the comparison.

12. The non-transitory machine-readable storage medium of claim 10, wherein the value is a first value, the provider is a first provider, and the operations further comprise:
receiving a second value from a second server of a second provider, the second value being offered for inclusion of a second provider identifier within the list of identifiers, the second provider identifier identifying the second provider; and wherein
the ranking of the user interface element includes:
calculating an average of the first value and the second value; and
assigning the average to the user interface element; and
the display of the user interface element among the set of user interface elements within the graphical user interface is based on the average.

13. The non-transitory machine-readable storage medium of claim 10, wherein the value is a first value, the provider is a first provider, the identifier position is a first identifier position, and the operations further comprise:
receiving a second value from a second server of a second provider, the second value being offered for inclusion of a second provider identifier within the list of identifiers, the second provider identifier identifying the second provider; and wherein
the ranking of the user interface element includes:
determining that the first value is a maximum value based on a comparison of the first value to the second value; and
assigning the maximum value to the user interface element; and
the display of the user interface element among the set of user interface elements within the graphical user interface is based on the maximum value.

14. The non-transitory machine-readable storage medium of claim 10, wherein the receiving of the value further comprises:
receiving a price quote with the value from the server of the provider; and
the operations further comprise:
determining that the price quote is a lowest price quote among a set of price quotes by a threshold margin; and
assigning the provider identifier a most prominent position among the list of identifiers in response to determining that the price quote is the lowest price quote by the threshold margin.

15. The non-transitory machine-readable storage medium of claim 10, wherein the value is a bid for the identifier position at which the provider identifier that identifies the provider is displayable among the list of identifiers.

16. The non-transitory machine-readable storage medium of claim 10, wherein the ranking the user interface element among the set of user interface elements within the graphical user interface based on the value from the provider includes:
assigning a rank indicator to the user interface element based on the value from the provider; and wherein
the causing of the display of the user interface element among the set of user interface elements includes:
causing the rank indicator to be displayed within the user interface element.

17. The non-transitory machine-readable storage medium of claim 10, wherein the user interface element includes a service identifier indicating a service offered by the provider.

18. A system comprising:
processors; and
a memory storing instructions that, when executed by at least one processor among the processors, cause the system to perform operations comprising:
receiving, by one or more processors of a machine, a value from a server of a provider, the value being offered for inclusion of a provider identifier within a list of identifiers, the provider identifier identifying the provider;
allocating the provider identifier to an identifier position within the list of identifiers based on the value from the server of the provider, the identifier position being within a user interface element among a set of user interface elements;
ranking, by one or more processors of the machine, the user interface element among the set of user interface elements based on the value from the provider; and
causing, by one or more processors of the machine, display of the user interface element among the set of user interface elements according to the ranking of the user interface element, within a graphical user interface, the displayed user interface element displaying the provider identifier within the list of identifiers and at the identifier position allocated based on the value received from the server of the provider.

19. The system of claim 18, wherein the value is a first value, the provider is a first provider, the provider identifier is a first provider identifier, the identifier position is a first identifier position, and the operations further comprise:
receiving a second value from a second server of a second provider, the second value being offered for inclusion of a second provider identifier within the list of identifiers, the second provider identifier identifying the second provider;
comparing the first value to the second value; and
the display of the first provider identifier includes:
displaying the first provider identifier instead of the second provider identifier at the first identifier position, and the second provider identifier at a second identifier position within the list of identifiers based on the comparison.

20. The system of claim 18, wherein the value is a first value, the provider is a first provider, and the operations further comprise:
receiving a second value from a second server of a second provider, the second value being offered for inclusion of a second provider identifier within the list of identifiers, the second provider identifier identifying the second provider; and wherein
the ranking of the user interface element includes:
calculating an average of the first value and the second value; and
assigning the average to the user interface element; and
the display of the user interface element among the set of user interface elements within the graphical user interface is based on the average.
